(19) United States
(12) Patent Application Publication
(10) Pub. No.: US 2017/0017389 A1
(43) Pub. Date: Jan. 19, 2017

(54) METHOD AND APPARATUS FOR SMART DEVICE MANIPULATION UTILIZING SIDES OF DEVICE

(71) Applicant: Korea Advanced Institute of Science and Technology, Daejeon (KR)

(72) Inventors: Geehyuk LEE, Daejeon (KR); Sunggeun AHN, Daejeon (KR); Jaeyeon LEE, Daejeon (KR); Keunwoo PARK, Daejeon (KR)

(21) Appl. No.: 14/964,082

(22) Filed: Dec. 9, 2015

(30) Foreign Application Priority Data
Jul. 13, 2015 (KR) 10-2015-0099082

(51) Int. Cl. G06F 3/0488; G06F 3/042; G06F 3/0482; G06F 3/041; G06F 3/0485; G06F 3/0484

(52) U.S. Cl. CPC G06F 3/04883; G06F 3/0485; G06F 3/04845; G06F 3/0482; G06F 3/04847; G06F 3/0416; G06F 3/0421; G06F 2203/04104; G06F 2203/04808; G06F 2203/04101

(57) ABSTRACT

An electronic device is provided, including an input unit configured for a manipulation of the smart device, wherein the input unit includes a touch screen coupled with a display of the smart device, and assistant input means associated with the touch screen extending to a plurality of sides of the smart device or associated with touch sensors formed on the plurality of sides, and configured to detect a touch on the side, wherein the touch detected by at least one of the touch screen and the assistant input means is recognized as an input signal for the manipulation.

### CROSS-REFERENCE TO RELATED APPLICATION(S)

This application claims the benefit under 35 U.S.C. §119(a) of a Korean patent application filed on Jul. 13, 2015 in the Korean Intellectual Property Office and assigned Serial number 10-2015-0099082, the entire disclosure of which is hereby incorporated by reference.

### TECHNICAL FIELD

Embodiments of the present disclosure relate to an input unit for smart device manipulation and an interaction method using the input device.

### BACKGROUND

Technological development is gradually accelerating the advancement of wearable computers. Generally, wearable computers are referred as kinds of portable computing devices, which are customarily worn on human bodies all the time, likewise clothing, watches, glasses, accessories, and so on.

Smart phones or tablet PCs are normally used with fingers or touch pens in convenience, but it is inevitable for them to meet some inconvenience that those should be moved in pockets or bags, or in hands. To the contrary, wearable computers may be more convenient in portability than such smart phones of tablet PCs because they can be worn on human bodies and allow human to freely move.

In recent years, various kinds of smart watches are emerged as portable computing devices wearable on wrists. Smart watches can embed diverse functions therein. For example, smart watches may embed many functions such as telephone, e-mail, messaging (SMS, MMS), Social Network Service (SNS), music, photograph, camera, motion picture, Near Field Communication (NFC), Global Positioning System (GPS), Wi-Fi, FM radio, check for moving distance or speed, cooperation with other devices such as smart phone, tablet, or laptop computer, and so on therein. Smart watches must be limited to their size because they are worn on human wrists. Small touch screens could meet two problems, roughly, in use. The first problem is that screen hiding by fingers becomes more critical in a small touch screen than in a large touch screen. The second is to have a limit to multifinger manipulation which affluently extends the functionality of touch screen input.

Touch screens are inevitable to meet screen hiding by fingers. Especially, small touch screens are more inconveniently affected from screen hiding because they have relatively large rates of the screen hiding by fingers in the full size. Furthermore, a smaller screen is insufficient to allow a manipulation with two or more fingers. Since a smaller size of screen results in a smaller amount of information visible on a single screen, more frequent manipulations are required to access desired information. Such hardness in multifinger manipulation extending input functionality means that it is inconvenient and difficult to access desired information in smart watches.

### SUMMARY

Aspects of the present disclosure are to address at least the above-mentioned problems and/or disadvantages and to provide at least the advantages described below. Accordingly, an aspect of the present disclosure is directed to provide a method and apparatus for smart device manipulation capable of improving usability of a smart device.

Another aspect of the present disclosure is directed to provide a method and apparatus for smart device manipulation capable of extending input functionality of a smart device.

In accordance with an aspect of the present disclosure, a smart device may include an input unit configured for a manipulation of the smart device, wherein the input unit may include a touch screen coupled with a display of the smart device, and assistant input means associated with the touch screen extending to a plurality of sides of the smart device or associated with touch sensors formed on the plurality of sides, and configured to detect a touch on the side, wherein the touch detected by at least one of the touch screen and the assistant input means may be recognized as an input signal for the manipulation.

In an embodiment, the smart device may be a tetragonal device having four upper/lower/left/right sides, and the assistant input means may be formed on each of the four sides and configured to sense a touch on each of the four sides.

In an embodiment, the touch detected by the assistant input means may be input as a coordinate value of an orthogonal coordinate system corresponding to the four sides.

In an embodiment, the input signal may be recognized with a combination of touches detected by the touch screen and at least one of the assistant input means, or recognized with a combination of touches detected by two or more of the assistant input means.

In an embodiment, the assistant input means may be used as means configured to select at least one of an X-axis coordinate value and a Y-axis coordinate value to a screen of the display.

In an embodiment, the assistant input means may be used as means configured to pan a target, which is shown on the display, to at least one of an X-axis direction and a Y-axis direction.

In an embodiment, the assistant input means may be used as means configured to control at least one of a zooming-in and a zooming-out for a target shown on the display.

In an embodiment, the assistant input means may be used as a modifier key configured to modify an input through the touch screen.

In an embodiment, the assistant input means may be used as means configured to show a menu index on the display or to select menus of the menu index disposed corresponding to the sides.

In accordance with another aspect of the present disclosure, a manipulation method for a smart device, the smart device including an input unit configured for a manipulation of the smart device, the input unit including: a touch screen coupled with a display of the smart device; and assistant input means associated with the touch screen extending to a plurality of sides of the smart device or associated with touch sensors formed on the plurality of sides, and configured to detect a touch on the side, may includes the steps of recognizing a touch, which is detected by at least one of the touch screen and the assistant input means, as an input signal for the manipulation; and performing an operation corresponding to the touch according to the input signal.

In accordance with still another aspect of the present disclosure, a program operating in a smart device, the smart device including an input unit configured for a manipulation of the smart device, the input unit including: a touch screen coupled with a display of the smart device; and assistant input means associated with the touch screen extending to a plurality of sides of the smart device or associated with touch sensors formed on the plurality of sides, and configured to detect a touch on the side, may include the steps of recognizing a touch, which is detected by at least one of the touch screen and the assistant input means, as an input signal for the manipulation; and performing an operation corresponding to the touch according to the input signal.

According to embodiments of the present disclosure, it may be allowable to effectively improve the usability of a small-screen smart device by utilizing side touch inputs as assistant inputs in the smart device employing a touch screen.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

FIG. 1 is a block diagram illustrating an internal configuration of a smart watch according to an embodiment of the present disclosure.

FIG. 2 is an exemplary diagram illustrating input means available for side manipulation in a smart watch according to an embodiment of the present disclosure.

FIG. 3 is an equivalent circuit diagram illustrating an optical sensor for detecting side touches on a smart watch according to an embodiment of the present disclosure.

FIGS. 4 to 6 are exemplary diagrams showing input manipulations using a touch screen and sides of a smart watch according to embodiments of the present disclosure.

FIGS. 7 to 13 are exemplary diagrams showing target control features using side manipulations of a smart watch according to embodiments of the present disclosure.

### DETAILED DESCRIPTION

Hereinafter, various embodiments of the present disclosure will be described in conjunction with the accompanying drawings. Various embodiments described herein, however, may not be intentionally confined in specific embodiments, but should be construed as including diverse modifications, equivalents, and/or alternatives. With respect to the descriptions of the drawings, like reference numerals refer to like elements.

Embodiments of the present disclosure are concerned with input technology for smart device manipulation. In particular, embodiments of the present disclosure are involved in an assistant input unit for supplementing usability that is inconvenient due to a small screen size of a smart device, and in an interaction method using the assistant input unit.

In the specification, the term ‘smart device’ may include a wearable computer, a smart phone, a tablet PC, and so on. Hereinbelow, a smart watch may be exemplified as a typical one of the smart device.

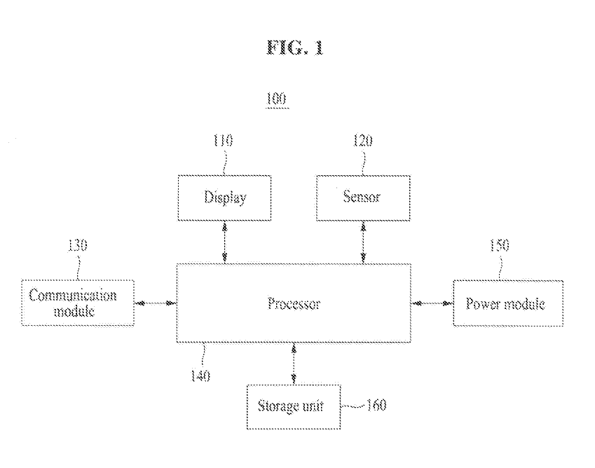

FIG. 1 is a block diagram illustrating an internal configuration of a smart watch according to an embodiment of the present disclosure.

Referring to FIG. 1, a smart watch 100 may include a display 110, a sensor 120, a communication module 130, a processor 140, a power module 150, and a storage unit 160.

The display 110 may output an image to a display screen. Additionally, the display 110 may output an image based on contents executed in the processor 140 or a control instruction of the processor 140. For example, contents may include various kinds of motion pictures.

The sensor 120 may detect an input signal through at least one sensor installed in the smart watch 100 and may transmit the detected input signal to the processor 140. The sensor 120 may include a plurality of sensing means. For example, a plurality of sensing means may include a gravity sensor, a geomagnetic sensor, a motion sensor, a gyro sensor, an acceleration sensor, an infrared sensor, a inclination sensor, a luminance sensor, an altitude sensor, a smell sensor, a temperature sensor, a depth sensor, a pressure sensor, a bending sensor, an audio sensor, a video sensor, a Global Positioning System (GPS) sensor, a grip sensor, a touch sensor, and so on. The sensor 120 may be inclusively named with the aforementioned sensing means in variety.

Additionally, the sensor 120 may sense diverse inputs and environments by a user and may transfer sensing results to the processor 140 to allow the processor 140 to perform operations according to the sensing results. The aforementioned sensors may be included in the smart watch 100 as additional elements, or may be integrated in one or more elements.

The sensor 120 may include a touch screen coupled with the display 110. An input signal to the smart watch 100 may be based on a touch input to the touch screen and additionally may include an eyes input, a voice input, a gesture input, and so on.

Especially, the sensor 120 may detect an input signal by using at least one sensor which is equipped on a side of the smart watch 100 and may transmit the detected input signal to the processor 140. This configuration will be described later in detail below.

The communication module 130 may communicate with an external device through diverse protocols to transmit/receive data. Additionally, the communication module 130 may transmit/receive digital data, such as contents, in connection with a wired or wireless network. The smart watch 100 may perform a pairing service with an external digital device. Additionally, the smart watch 100 may communicate with an external digital device through a pairing service.

The processor 140 may execute contents which is received through data communication or stored in the storage unit 160. The processor 140 may control units of the smart watch 100, and may control data transmission and reception among the units. The processor 140 may detect an external digital device which is paired with the smart watch 100. Especially, the processor 140 may control an operation of the smart watch 100 based on a detected input signal through a touch screen and at least one side of the smart watch 100.

The power module 150, as a power source connected with an internal battery of the smart watch 100 or an external power source, may supply power to the smart watch 100. The power module 150 may supply power to a part or all of components or units of the smart watch 150. For example, the power module 150 may include a power management system, one or more power sources such as battery or AC supply, a charging system, a power failure detection circuit, a power converter or inverter, a power state indicator, or other components for generating, managing, and distributing power.

The storage unit 160 may store diverse digital data such as motion pictures, audio files, photographs, applications, and so on. The storage unit 150 may store programs for process and control of the processor 140 and may perform functions for temporarily storing input/output data. The storage unit 160 may include a high-speed Random Access Memory (RAM), a magnetic disk, a Static RAM (SRAM), a Dynamic RAM (RAM), a Read-Only Memory (ROM), a flash memory, or a nonvolatile memory.

The storage unit 160 may include a software module, an instruction set, or other diverse data which are necessary for operations of the smart watch 100. Access to the storage unit 160 from the processor 140 or other components may be controlled by the processor 140.

Additionally, although not shown in FIG. 1, the smart watch 100 may further include an audio unit. The audio unit may provide information, which is based on contents executed in the processor 140 or control instructions of the processor 140, by voice.

Many operations executed in the smart watch 100 may be controlled by the processor 140. Additionally, operations of the smart watch 100 may be controlled by applications which are stored in the storage unit 160 and driven by the processor 140. For convenience of description and illustration, these operations will be generally regarded as being controlled by the smart watch 100 throughout the accompanying drawings and the following description.

An embodiment shown in FIG. 1 is merely exemplified for the smart watch 100. The smart watch 100 may be configured without a part of the components shown in FIG. 1, with an additional component not shown in FIG. 1, or with two or more components. Components includable in the smart watch 100 may be implemented in hardware including an integrated circuit specified for processing one or more signals or applications, software, or a combination of such hardware and software.

The smart watch 100 shown in FIG. 1 is illustrated in functional blocks in which elements or components of the smart watch 100 are divisionally arranged by logical differentiation. Therefore, the elements of the smart watch 100 may be installed in a single chip or a plurality of chips in accordance with a design of the device.

In embodiments of the present disclosure, it may be necessary to have assistant input means capable of (1) solving screen hiding, and (2) extending input functionality, improving usability in a smart watch employing a touch screen.

Screen hiding in a smart watch may be removed by shifting a manipulation space to the side from the upside of the smart watch. However, a side manipulation can be less efficient than an upside manipulation in intuition. For that reason, a manipulation on a side of the smart watch may be supplementarily utilized in the case that the screen hiding seriously affects its usability. For example, a side manipulation of a smart watch may be used for the case of selecting a small target which is difficult to be selected on a touch screen of the smart screen.

In an embodiment, target selection on a touch screen of a smart watch may be based on an orthogonal coordinate system and a manipulation method may be available in four sides of a tetragonal smart watch having polygonal surfaces which are apparently sectioned.

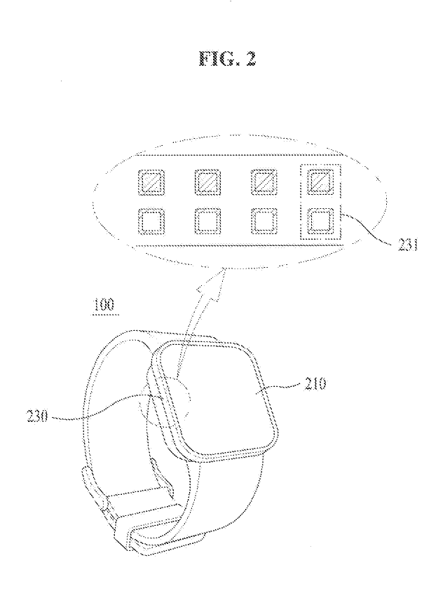

FIG. 2 is an exemplary diagram illustrating input means available for a side manipulation in a smart watch according to an embodiment of the present disclosure.

Referring to FIG. 2, a smart watch 100 may include a touch screen 210 as input means which is coupled with a display. Especially, a side space 230 of the smart watch 100 may be formed as assistant input means. With this configuration, the smart watch 100 may utilize four side spaces 230 as assistant input means.

Although FIG. 2 is illustrated as the side space 230 is divided into four areas in the tetragonal smart watch 100, embodiments of the present disclosure may not be restrictive hereto and may be also applicable to any form which has at least one or more side spaces such as round, triangle, or so on. For example, although the body of the smart watch 100 is shaped in a round, it may be permissible to define a side space of the round as multiple areas which are comparted into upper/lower, left/right, or upper/lower/left/right areas for use, as well as to use the side space as input means in itself.

The side space 230 of the smart watch 100 may include means for sensing a touch. For example, an optical sensor 231 may be employed in the side space 230. In this configuration, the optical sensor 231 may be made up with a pair of Light Emitting Diode (LED) and photosensor. The optical sensor 231 may be formed in 8 for each side of the side space 230.

The optical sensor 231 included in the side space 230 of the smart watch 100 may be formed in a mode that a photosensor thereof senses reflection of infrared, which is generated from an LED, on a finger. As such a mode can be used to measure an interval between the optical sensor 231 and a finger, it may be practicable to sense whether there is a touch to the side space 230 of the smart watch 100.

In the smart watch 100, the optical sensor 231 may allow to sense a touch, a touching area, a touching orientation, and a touching position.

With respect to the biggest one among 8 sensor values and two sensors adjacent to the biggest-valued sensor, a parameter for touch detection is made by summing differences (variations along time) between (1) current measurement values and (2) previous measurement values, and a touch state may be recognized if the parameter becomes over a specific reference.

Additionally, it may be allowable to estimate a position of a finger, which is touching in the sides, by using measurement values of the sensors arranged on the sides. Finger position estimation may use the center of gravity of measurement values. During this, all sensor values may be regularized to have base values of 0 for preventing a shift of the center of gravity due to the base values of the sensors.

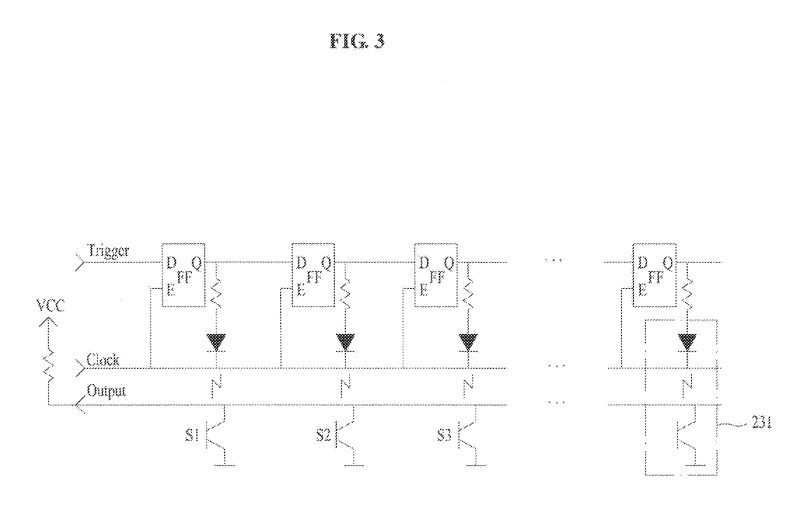

FIG. 3 is an equivalent circuit diagram illustrating an optical sensor for recognizing touches on the side space 230 shown in FIG. 2.

Although FIGS. 2 and 3 are simply illustrated with optical implementation for touch recognition on the side space 230, embodiments of the present disclosure may not be restrictive hereto and rather the touch detection may be diversely accomplished in an electrostatic mode, a resistive mode, or others. For example, even without additional assistant input means (e.g., an optical sensor) for detecting a side manipulation, a touch screen may be extended from the front to the upper/lower/left/right sides (or upper/lower or left/right sides) to detect a side touch through the touch screen.

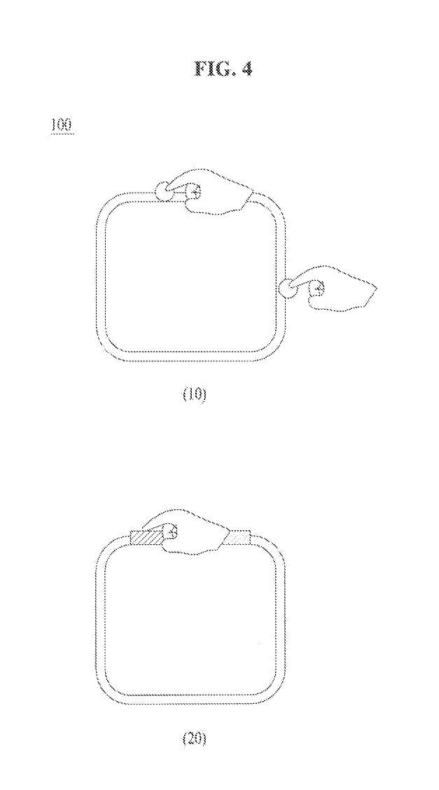

FIGS. 4 to 6 are exemplary diagrams showing input manipulations using a touch screen and sides of a smart watch, which are used as an input unit, according to embodiments of the present disclosure.

Referring to FIG. 4, manipulation 10 is to touch specific positions on sides for basic inputs, as same as a manipulation of touching on a touch screen. It may be allowable to touch at least one of four sides by a single finger or by two or more fingers coincidently. Manipulation 20 is also to touch a side with extension of a touching area.

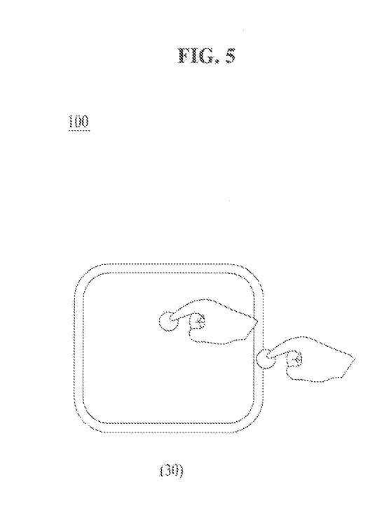

Referring to FIG. 5, manipulation 30 may be used with a side touch manipulation and a touch screen manipulation. In this case, a side may be used for a modifier key (e.g., Shift, Alt, or Ctrl key).

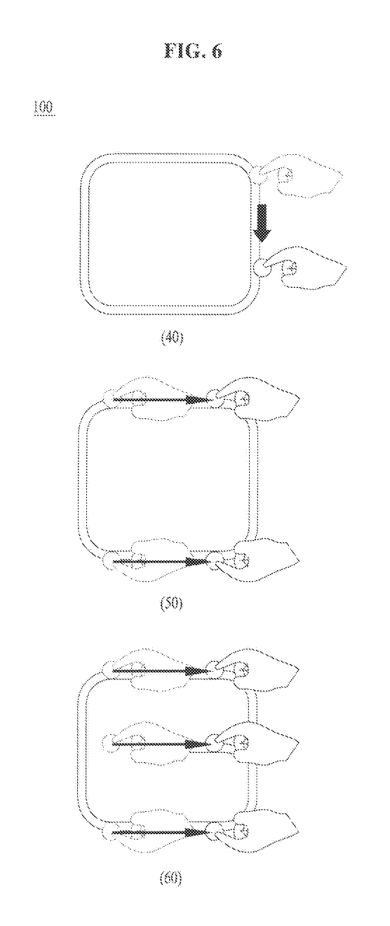

Referring to FIG. 6, manipulation 40 is relevant to a contiguous dragging as same as that on a touch screen in the manner of side touch manipulation. Manipulation 50 is a coincident dragging on two or more sides and manipulation 60 is a coincident dragging on at least one or more sides and a touch screen.

As aforementioned, the side touch manipulation of a smart watch 100 may be operable with a combination of side and touch screen manipulations, as well as only with a single input by a side touch.

Although FIGS. 4 to 6 are illustrated to describe exemplary touch manipulations, embodiments of the present disclosure may not be restrictive hereto. Input modes or their combinations on sides of the smart watch 100 may be diversely modified or extended to various forms.

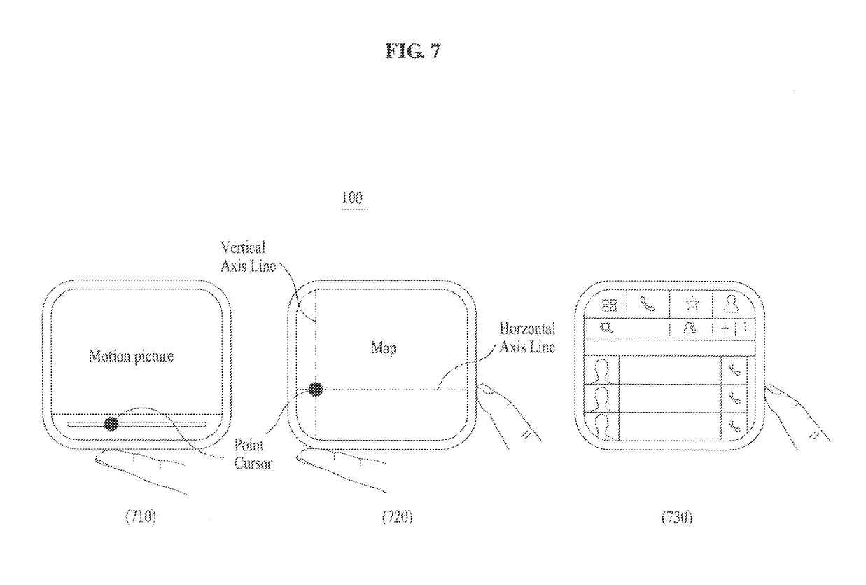

FIGS. 7 to 10 are exemplary diagrams showing target control features using side manipulations of a smart watch according to embodiments of the present disclosure.

Referring to FIG. 7, manipulation 710 is an image playing position manipulation using a one-dimensional slider. In which an image playing position may be selected through a touch on a lower surface among sides of the body of a smart watch 100 while a motion picture is playing in the smart watch 100. If a user touches the lower surface of the side in the smart watch 100, a menu bar may be activated to manipulate a playing position of a motion picture. During this, in the case that a user's finger moves along the corresponding side, the menu bar follows the user's finger and thereby the user may select a position for playing a motion picture.

Manipulation 720 is to select a specific position in a map shown in a display. X-axis and Y-axis coordinates may be selected through coincident touch combination of lower and right sides of the body. During this, an orthogonal coordinate system may be employed. The right side (or the left side) for inputting a Y-coordinate value may be coincidently used together with the lower side (or the upper side) for inputting an X-coordinate value. If the right and left sides of the smart watch 100 are touched by two fingers, a selection begins to generate a cursor at the corresponding position. In this condition, after moving the two fingers to shift the cursor to a desired (X,Y) position, the selection may be completed by removing one or more of the two fingers from the touching position. Accordingly, it may be allowable to exactly select a desired position without hiding a screen by fingers.

Manipulation 730 shows an embodiment applied to an address book search. A side manipulation may be used in the case of searching a name with its initial sound from a telephone number index shown in a display. In searching an initial sound in a smart phone, keys on which initial sound letters are marked in the right side of a screen may be displayed in a line and then, if one of the keys is selected, a screen turns to a position of a first contact number having the initial sound. On a small screen of a smart watch 100, keys become smaller to cause specific keys to be difficultly pressed. In this case, a side touch manipulation of the smart watch 100 may allow a desired key to be selected. For example, the right side of the smart watch 100 may be used to reach a position of an initial sound while a finger moves along the edge of the smart watch 100.

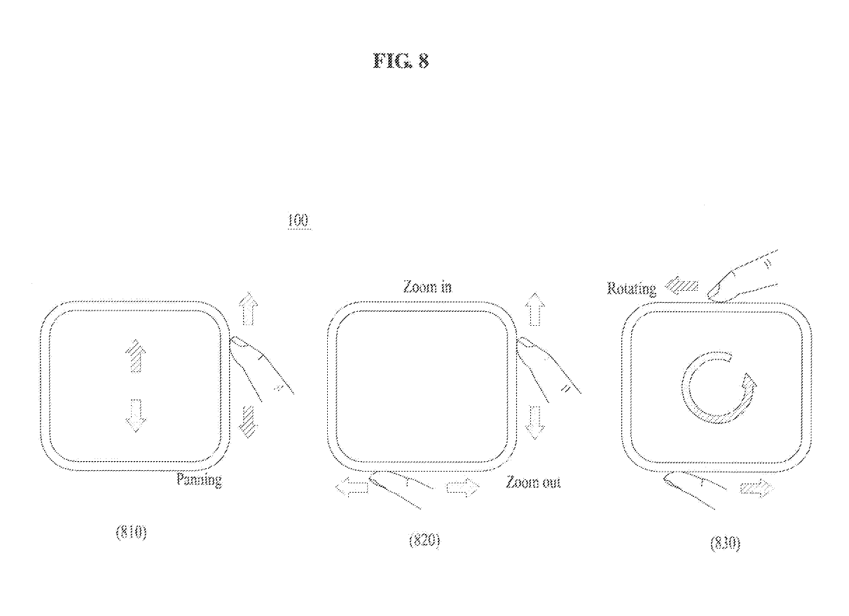

Referring to FIG. 8, manipulation 810 is for a panning mode which a finger moves along the edge in contact with a vertical side (e.g., the right side) and then shifts a target of a display toward the Y-axis direction. It may be also allowable to a finger to move along the edge in contact with a horizontal side (e.g., the lower side) and then shift a target of a display toward the X-axis direction.

In manipulation 820, it may be allowable to zoom in or out a target which is shown on a display. For example, a target of a display may be zoomed in or out through a coincident manipulation on the right and lower sides. For example, if two fingers move distantly from the right lower corner of the smart watch 100, a target of a display may be zoomed in. If two fingers move close to each other, a target of a display may be zoomed out.

Manipulation 830 is to rotate a target of a display. A target of a display may be rotated by moving two fingers to opposite directions of each other in contact with two sides in the same manner of physically rotating a thing. For example, in the condition that two fingers are coincidently in contact with the upper and lower sides of a smart watch 100 respectively, if the upper finger moves from the right to the right while the lower finger moves from the left to the right, a target of a display may rotate anti-clockwise. If the two fingers move in the reverse, a target of a display may rotate clockwise.

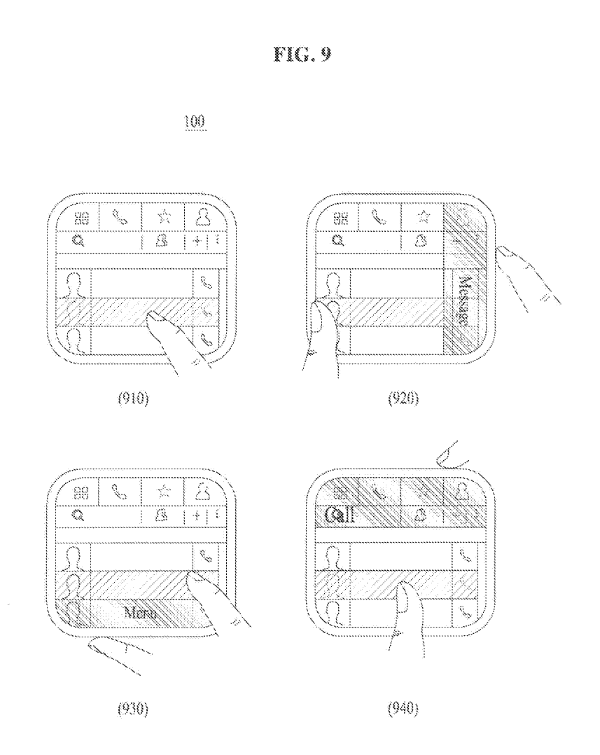

FIG. 9 exemplarily illustrates a manipulation of utilizing sides of a smart watch 100 as modifier keys. Four sides of the smart watch 100 may be utilized for modifier keys. These modifier keys may be similar to traditional mouse manipulations such as using Crtl, Alt, and Shift keys. Modifier keys may act to modify a condition of touch input which selects to execute an instruction by touching a finger to one or more of the four sides. For example, an icon may be selected by a left click of a mouse, a second icon may be added to a previously selected icon by selecting the second icon under the condition of pressing the Ctrl key, and all icons between a previously selected icon and a second icon may be selected under the condition of pressing the Shift key. Similarly, combinations with four side touches may be available when the touches are performed on a touch screen. This manipulation may create a more number of touch inputs, arithmetically extending to the 4-square of 2 at maximum, i.e., 16 touch inputs, than conventional touch inputs.

As an example of employing modifier keys in the smart watch 100, there is a case of using a call number application.

In manipulation 910, if a finger selects a target from a call number index without a side touch in the smart watch 100 under the condition that the call number index is shown on a display of the smart watch 100, a screen may go to a page showing detailed information of the selected target.

In manipulation 920, if a finger selects a specific target from a call number index while the right side of the smart watch 100 is touched by another finger, a screen may turn to a page for transmitting a message to the specific target.

In manipulation 930, if a finger selects a specific target from a call number index while the lower side of the smart watch 100 is touched by another finger, a menu control page for the specific target may appear in a screen.

In manipulation 940, if a finger selects a specific target from a call number index while the upper side of the smart watch 100 is touched by another finger, it may execute a call to the specific target.

Summarily, in selecting a specific call number from a call number index in which call numbers are arranged in a line, a target of the specific call number may be basically touched and selected on a touch screen. For example, it may be allowable to display menus for a messaging if the right side of the smart watch 100 is used as a modifier key, for a calling if the upper side is used as a modifier key, and for selecting a corresponding item if the lower side is used as a modifier key.

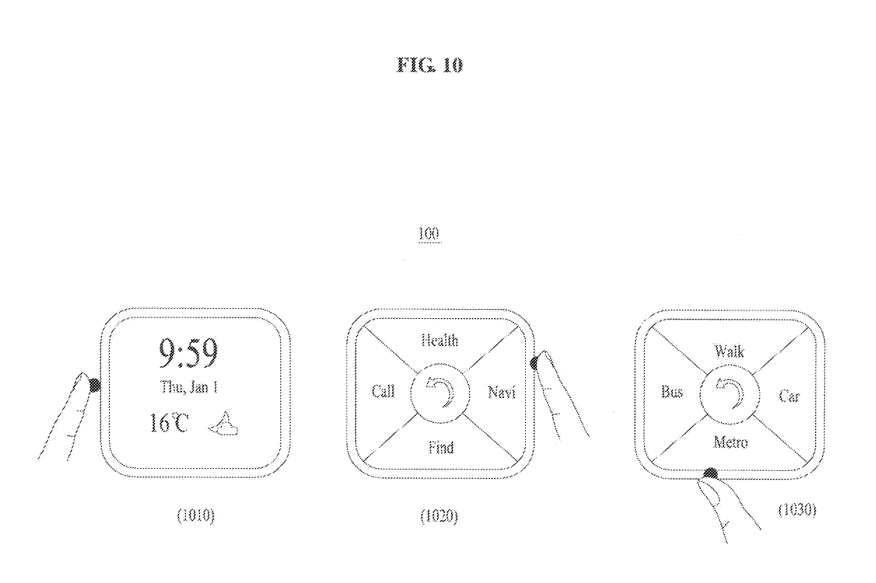

FIG. 10 exemplarily illustrates menu manipulations using sides of a smart watch 100.

Menus for approaching functions provided in the smart watch 100 are formed in a hierarchical structure where the menus sequentially turn to the next one by steps. A plurality of items (e.g., 4) is displayed at each step and each item may correspond to each side of the smart watch 100. For example, the number of items may be determined according to the number of sides sectioned in the smart watch 100 and the menus may be configured in a form that the sides correspond to the item one by one. Additionally, it may be permissible to make one side correspond to two or more items. Items may be selected if a finger is touched to a side corresponding thereto and then removed from the side. If the last item is selected after sequential selection by steps, a corresponding instruction may be performed.

For example, as shown in FIG. 10, if one or more sides are selected under the condition that a standby screen is present on a display of the smart watch 100 (1010), it may be allowable to display the highest menu index (1020). In this configuration, the menu index may respectively correspond to sides and the center of the menu index may be formed with a ‘Return’ key. If one side of the smart watch 100 is selected in the menu index (1020), a subordinate menu (1030) may be displayed in correspondence with the selected side. If a selected menu is the last item, a display may go to an execution screen for the selected menu. If there is a miss selecting items, it may be allowable to return to the previous menu by selecting the ‘Return’ key through a touch screen.

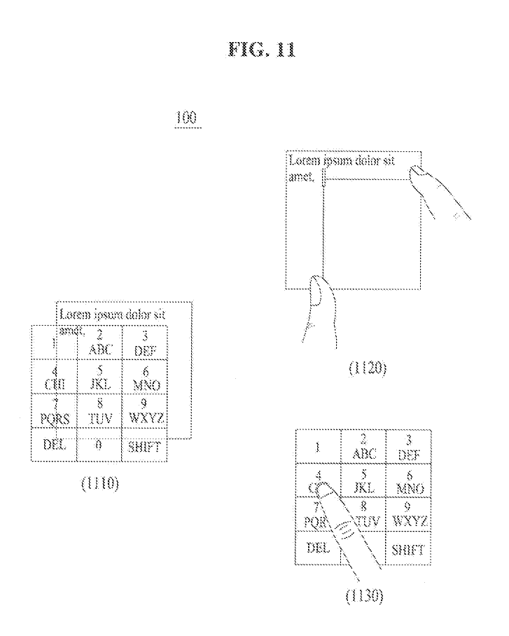

FIG. 11 exemplarily illustrates a manipulation for multilayer control using a side of a smart watch 100.

A side of the smart watch 100 may be utilized as an independent interface channel isolated from a screen area. For example, manipulations in a touch screen and a side may be independently performed through different layers.

As shown in FIG. 11, a layer of manipulation target may be determined according to which area is activated for manipulation in two targets, e.g., a soft keyboard and a text view (1110), sharing the space on a screen. For example, in manipulating a text view among the multilayer (1120), if the right and lower sides of the smart watch 100 are coincidently touched by two fingers, this coincident touch combination may specify two-dimensional coordinates corresponding to a touch screen and a cursor may be marked at the corresponding coordinates. And, if a finger touches a touch screen but a side of the smart watch 100 (1130), it may be allowable to manipulate a soft keyboard among the multilayer.

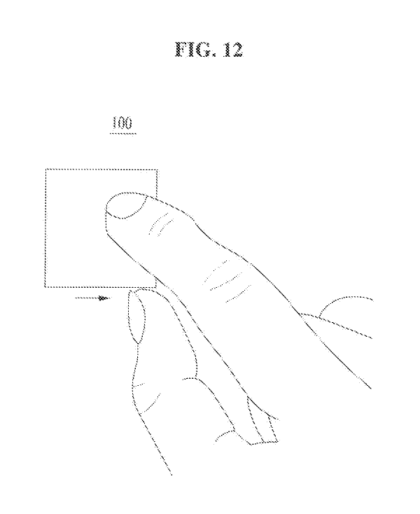

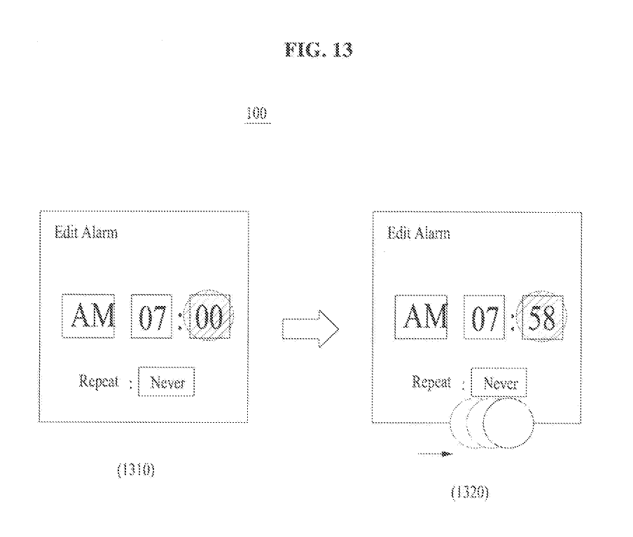

FIGS. 12 and 13 exemplarily illustrate manipulations for selective control using a side of a smart watch 100.

There are physically spatial limits to control using a gesture on a touch screen and control using an additional widget (key or slider). The limits may be caused from the insufficiency of rooms for a gesture on the touch screen and a disposition of an additional widget. To solve the insufficiency of rooms, as shown in FIG. 12, manipulations in a touch screen and a side of the smart watch 100 may be differentiated to divisionally select a target to be manipulated in the touch screen, and to allow adjustment of a parameter for the selected target through the manipulation on the side. For example, FIG. 13 illustrates a time editing process for setting an alarm in a smart watch 100. In manipulation 1310, a touch screen area of the smart watch 100 may be touched to select a time field to be adjusted. In manipulation 1320, if the touch moves along the edge of a side toward a direction under the condition that the time field is selected, it may be permissible to adjust a time in the direction. For example, if a contiguous touch to a side of the smart watch 100 moves from the left to the right (or from the lower to the higher), it may be adjustable to increase a parameter. If a contiguous touch moves in the reverse direction, a parameter may be adjusted to decrease.

Manipulation methods of a smart watch according to embodiments of present disclosure may include two or more operations based on the descriptions of FIGS. 1 to 13.

As described above, by employing sides as assistant input means in a smart watch using a touch screen, it may be accomplishable to improve the usability of the touch screen of the smart watch and to effectively eliminate problems of screen hiding, hence extending the input functionality in the smart watch.

Methods according to embodiments of the present disclosure may be implemented in forms of program instructions executable through various kinds of computer systems, and may be recorded in computer-readable media.

An apparatus or unit described above may be implemented in hardware elements, software elements, and/or a combination of hardware and software elements. For example, an apparatus, unit, or element described above may be implemented with one or more universal or special computers, such as processor, controller, Arithmetic Logic Unit (ALU), digital signal processor, microcomputer, Field Programmable Gate Array (FPGA), Programmable Logic Unit (PLU), microprocessor, or other units capable of executing and responding instructions. A processing unit may perform an Operating System (OS) and one or more software applications executed in the OS. Additionally, a processing unit may access, store, control, and generate data in response to software executions. Although some embodiment is illustrated as employing one processing unit for convenience of understanding, it can be seen by those skilled in the art that a plurality and/or diversity of processing elements may be included in use. For example, a processing unit may include a plurality of processors or one processor and one controller. Additionally, a processing unit may be formed in other processing configuration like a parallel processor.

Software may include computer programs, codes, instructions, or one or more combinations with them, may configure a processing unit, or may control a processing unit independently or collectively. For being interpreted by a processing unit or for providing instructions or data to a processing unit, software and/or data may be embodied permanently or temporarily in some kind of machine, component, physical apparatus, virtual equipment, computer storage medium or unit, or transmitted signal wave. Software may be distributed in computer systems connected through a network and may be stored and executed in distribution. Software and data may be stored in one or more computer-readable recording media.

Methods according to embodiments of the present disclosure may be implemented in the form of program instructions executable through diverse computing means and may be recorded in computer readable media. The computer readable media may include independently or associatively program instructions, data files, data structures, and so on. Program instructions recorded in the media may be specially designed and configured for embodiments, or may be generally known by those skilled in the computer software art. Computer readable recording media may include magnetic media such as hard disks and floppy disks, optical media such as CD-ROM and DVD, magneto-optical media such as floptical disks, and hardware units, such as ROM, RAM, flash memory, and so on, which are intentionally formed to store and perform program instructions. Program instructions may include high-class language codes executable by computers using interpreters, as well as machine language codes likely made by compilers. The hardware units may be configured to function as one or more software modules for performing operations according to embodiments of the present disclosure, and vice versa.

While embodiments of the present disclosure have been shown and described with reference to the accompanying drawings thereof, it will be understood by those skilled in the art that various changes and modifications in form and details may be made therein without departing from the spirit and scope of the present disclosure as defined by the appended claims and their equivalents. For example, it may be allowable to achieve desired results although the embodiments of the present disclosure are preformed in other sequences different from the descriptions, and/or the elements, such as system, structure, device, circuit, and so on, are combined or assembled in other ways different from the descriptions, replaced or substituted with other elements or their equivalents.

Therefore, other implementations, other embodiments, and equivalents of the appended claims may be included in the scope of the appended claims.

What is claimed is:

1. A smart device comprising:
an input unit configured for a manipulation of the smart device,
wherein the input unit comprises:
a touch screen coupled with a display of the smart device; and
assistant input means associated with the touch screen extending to a plurality of sides of the smart device or associated with touch sensors formed on the plurality of sides, and configured to detect a touch on the side,
wherein the touch detected by at least one of the touch screen and the assistant input means is recognized as an input signal for the manipulation.

2. The smart device of claim 1, wherein the smart device is a tetragonal device having four upper/lower/left/right sides, and
wherein the assistant input means is formed on each of the four sides and configured to sense a touch on each of the four sides.

3. The smart device of claim 2, wherein the touch detected by the assistant input means is input as a coordinate value of an orthogonal coordinate system corresponding to the four sides.

4. The smart device of claim 1, wherein the input signal is recognized with a combination of touches detected by the touch screen and at least one of the assistant input means, or recognized with a combinations of touches detected by two or more of the assistant input means.

5. The smart device of claim 1, wherein the assistant input means is used as means configured to select at least one of an X-axis coordinate value and a Y-axis coordinate value to a screen of the display.

6. The smart device of claim 1, wherein the assistant input means is used as means configured to pan a target, which is shown on the display, to at least one of an X-axis direction and a Y-axis direction.

7. The smart device of claim 1, wherein the assistant input means is used as means configured to control at least one of a zooming-in and a zooming-out for a target shown on the display.

8. The smart device of claim 1, wherein the assistant input means is used as a modifier key configured to modify an input through the touch screen.

9. The smart device of claim 1, wherein the assistant input means is used as means configured to show a menu index on the display or to select menus of the menu index disposed corresponding to the sides.

10. The smart device of claim 1, wherein if a multilayered screen is shown on the display, the touch screen and the assistant input means are used as means configured to manipulate different layers.

11. The smart device of claim 1, wherein the assistant input means is used as means configured to adjust a parameter for a target selected through the touch screen.

12. A manipulation method for a smart device, the smart device including an input unit configured for a manipulation of the smart device, the input unit including: a touch screen coupled with a display of the smart device; and assistant input means associated with the touch screen extending to a plurality of sides of the smart device or associated with touch sensors formed on the plurality of sides, and configured to detect a touch on the side, the manipulation method comprising:
recognizing a touch, which is detected by at least one of the touch screen and the assistant input means, as an input signal for the manipulation; and
performing an operation corresponding to the touch according to the input signal.

13. The manipulation method of claim 12, wherein the smart device is a tetragonal device having four upper/lower/left/right sides,
wherein the assistant input means is formed on each of the four sides and configured to sense a touch on each of the four sides, and
wherein the touch detected by the assistant input means is input as a coordinate value of an orthogonal coordinate system corresponding to the four sides.

14. The manipulation method of claim 12, wherein the recognizing comprises:
recognizing a combination of touches detected by the touch screen and at least one of the assistant input means or recognizing a combination of touches detected by two or more of the assistant input means.

15. The manipulation method of claim 12, wherein the recognizing comprises:
recognizing a touch, which is detected by the assistant input means, as an input signal for selecting at least one of an X-axis coordinate value and a Y-axis coordinate value to a screen of the display.

16. The manipulation method of claim 12, wherein the recognizing comprises:
recognizing a touch, which is detected by the assistant input means, as an input signal for panning a target, which is shown on the display, to at least one of an X-axis direction and a Y-axis direction.

17. The manipulation method of claim 12, wherein the recognizing comprises:
recognizing a touch, which is detected by the assistant input means, as an input signal for controlling at least one of a zooming-in and a zooming-out for a target shown on the display.

18. The manipulation method of claim 12, wherein the recognizing comprises:
recognizing a touch, which is detected by the assistant input means, as a modifier key signal for modifying an input signal according to a touch detected by the touch screen.

19. The manipulation method of claim 12, wherein the recognizing comprises:
recognizing a touch, which is detected by the assistant input means, as an input signal for showing a menu index on the display or as an input signal for selecting menus of the menu index disposed corresponding to the sides.

20. A program operating in a smart device, the smart device including an input unit configured for a manipulation of the smart device, the input unit including: a touch screen coupled with a display of the smart device; and assistant input means associated with the touch screen extending to a plurality of sides of the smart device or associated with touch sensors formed on the plurality of sides, and configured to detect a touch on the side, the program comprising:
recognizing a touch, which is detected by at least one of the touch screen and the assistant input means, as an input signal for the manipulation; and
performing an operation corresponding to the touch according to the input signal.
